(19) United States
(12) Patent Application Publication
(10) Pub. No.: US 2015/0097397 A1
(43) Pub. Date: Apr. 9, 2015

(54) MOTOR VEHICLE BODY

(71) Applicant: GM GLOBAL TECHNOLOGY OPERATIONS LLC, Detroit, MI (US)

(72) Inventors: Ingo Fettel, Hainburg (DE); Ralf Krug, Ruesselsheim (DE); Axel Boywitt, Weiterstadt (DE)

(21) Appl. No.: 14/506,428

(22) Filed: Oct. 3, 2014

(30) Foreign Application Priority Data
Oct. 4, 2013 (DE) 102013016565.2

(51) Int. Cl. B60J 7/00; B62D 65/06

(52) U.S. Cl. CPC B60J 7/003; B62D 65/06
USPC 296/216.04; 29/897.2

(57) ABSTRACT

The present disclosure relates to a motor vehicle body with a lateral roof frame, a sliding roof structure and an angled connecting flange with a first web and second web. The first web is connected in a frictionally and/or positively joined manner to the lateral roof frame by means of a first elongated hole arrangement. The second web is connected to the sliding roof structure in a frictionally or positively joined manner by means of a second elongated hole arrangement.

### CROSS REFERENCE TO RELATED APPLICATION

This application claims priority to German Patent Application No. 102013016565.2 filed Oct. 4, 2013, which is incorporated herein by reference in its entirety.

### TECHNICAL FIELD

The technical field relates to a motor vehicle body with a lateral roof frame and a sliding roof structure as well as a method for producing such a motor vehicle body.

### BACKGROUND

DE 10 2006 014 721 A1 generally discloses a motor vehicle body with a lateral roof frame and a module for a sliding roof running outside, which is connected to the lateral roof frame via flanges and a two-part console. The two-part console is not explained in more detail nor is the manner in which the console is fastened to a B-pillar and a frame structure of the module further explained in more detail.

### SUMMARY

The present disclosure provides an improvement in the production of a motor vehicle body. According to an aspect of the present disclosure, a motor vehicle body includes a first lateral roof frame and a sliding roof structure, which is connected to this lateral roof frame. In an embodiment, the motor vehicle body includes a second lateral roof frame, which is located opposite and preferably identically mirror-images the first later roof frame, connected to the sliding roof structure. While the present disclosure describes only the connection of the sliding roof structure to the one lateral roof frame, the embodiments will be understood to apply analogously to the connection of the sliding roof structure to the other lateral roof frame also.

In an embodiment, the sliding roof structure may be a roof reinforcement and/or a housing or a part of a housing for a sliding roof which in particular runs on the inside or outside. In an embodiment, the sliding roof structure is designed frame-like and includes a longitudinal leg. The longitudinal leg can support itself from the top and/or bottom on the lateral roof frame as seen in vehicle vertical direction.

In an embodiment, the motor vehicle body includes an angled connecting flange that is in particular unitarily or integrally produced. As presently preferred, the flange is formed with a first web and a second web, which is or will be connected to the lateral roof frame and the sliding roof structure. In a further development, the motor vehicle body includes one or more connecting flanges which are preferably designed and connected or will be connected in the same manner. Again, the present disclosure describes only one connecting flange, but it will be understood that the explanations apply analogously to one or more connecting flanges.

According to an aspect of the present disclosure, the first web is connected to the lateral roof frame in a frictionally and/or positively joined manner by means of a first elongated hole arrangement. The first elongated hole arrangement includes at least one, preferably at least two, and in particular three or more elongated holes. In a further development, all elongated holes of the first elongated hole arrangement are aligned at least substantially in vehicle vertical direction. Because of this, a tolerance in vehicle vertical or z-direction during the connecting of lateral roof frame and sliding roof structure can be advantageously compensated in an embodiment. Additionally or alternatively, such elongated holes can facilitate assembly and disassembly.

According to an aspect of the present disclosure, the second web is additionally or alternatively connected in a frictionally and/or positively joined manner to the sliding roof structure by means of a second elongated hole arrangement. The second elongated hole arrangement includes at least one, preferably at least two, and in particular three or more elongated holes. Elongated holes of the first and second elongated hole arrangement can be arranged in vehicle longitudinal direction in same and/or different positions. In a further development all elongated holes of the second elongated hole arrangement are oriented at least substantially in vehicle transverse direction. Because of this, a tolerance in vehicle transverse or y-direction can be advantageously compensated during the connection of lateral roof frame and sliding roof structure. Additionally or alternatively, such elongated holes can facilitate assembly and disassembly.

In an embodiment, the elongated holes of the first and/or second elongated hole arrangement are or will be each engaged through by a threaded pin, which on one or both sides is screwed together with a nut or similar female threaded element and connects the first web of the connecting flange to the roof frame or the second web of the connecting flange to the sliding roof structure in a frictionally joined manner. Because of this, play can be initially made available in an elongated hole longitudinal direction in an embodiment and the connecting flange subsequently fixed in a frictionally joined manner by tightening the threaded pins.

A threaded pin can be permanently connected to the one of the connecting flange, the roof frame and the sliding roof structure. In particular, the threaded pin can be designed integrally therewith or connected therewith in a materially joined manner. Such a threaded pin can then engage through an elongated hole in the other one of the connecting flange, the roof frame and the sliding roof structure and on its free end be or will be screwed together with a nut or similar female threaded element. In particular a threaded pin which is permanently connected to the first web can also engage through an elongated hole in the groove frame and be screwed together with a nut or similar female threaded element on the side of the roof frame located opposite the first web. Conversely, a threaded pin which is permanently connected to the roof frame can engage through an elongated hole in the first web and be screwed together with a nut or similar female threaded element on the side of the first web located opposite the roof frame.

Additionally or alternatively, a threaded pin which is permanently connected to the second web can engage through an elongated hole in the sliding roof structure and be screwed together with a nut or similar female threaded element on the side of the sliding roof structure located opposite the second web. Equally, a threaded pin which is permanently connected to the sliding roof structure can engage through an elongated hole in the second web and be screwed together with a nut or similar female threaded element on the side of the second web located opposite the sliding roof structure. Because of this, an assembly effort can be reduced and/or a connection improved in an embodiment.

Equally, a threaded pin can engage through a hole in the connecting flange and a further hole in the roof frame or the sliding roof structure and be or will be screwed together with a nut or similar female threaded element on a free end, wherein one of these holes or both holes are designed as elongated hole.

In a further development, the elongated holes of the first elongated hole arrangement, which are formed in the first web and in the lateral roof frame, are each at least substantially oriented in vehicle vertical direction and/or the elongated holes of the second elongated hole arrangement, which are formed in the second web and the sliding roof structure, are each at least substantially oriented in vehicle transverse direction. In another embodiment, the elongated holes of the first elongated hole arrangement, which are formed in the first web, can also be formed at least substantially in vehicle vertical direction and the elongated holes of the first elongated hole arrangement, which are formed in the lateral roof frame, can be at least substantially oriented in vehicle longitudinal direction, or the elongated holes of the first elongated hole arrangement, which are formed in the first web, can be formed at least substantially in vehicle longitudinal direction and the elongated holes of the first elongated hole arrangement, which are formed in the lateral roof frame, can be oriented at least substantially in vehicle vertical direction.

Additionally or alternatively, the elongated holes of the second elongated hole arrangement, which are formed in the second web, can be formed at least substantially at least in vehicle transverse direction and the elongated holes of the second elongated hole arrangement, which are formed in the sliding roof structure, can be oriented at least substantially in vehicle longitudinal direction, or the elongated holes of the second elongated hole arrangement, which are formed in the second web, can be formed at least substantially in vehicle longitudinal direction and the elongated holes of the second elongated hole arrangement, which are formed in the sliding roof structure can be oriented at least substantially in vehicle transverse direction.

In an embodiment, through a first elongated hole arrangement with elongated holes in the first web and in the lateral roof frame, which are oriented in different directions, in particular, at least substantially, in vehicle vertical and longitudinal direction, and/or through an elongated hole arrangement with elongated holes in the sliding roof structure and in the second web, which are oriented in different directions, in particular, at least substantially, in vehicle transverse and longitudinal direction, tolerances in two directions can thus be advantageously compensated in each case.

Thus, a threaded pin in particular can engage through an elongated hole in the first web and a round hole in the roof frame or a round hole in the first web and an elongated hole in the roof frame or an elongated hole in the first web and an elongated hole in the roof frame, which in particular at least substantially are oriented in vehicle vertical and longitudinal direction or both in vehicle vertical direction and be screwed together with a nut or similar female threaded element in each case on both sides. Equally, a threaded pin can engage through an elongated hole in the second web and a round hole in the sliding roof structure or a round hole in the second web and an elongated hole in the sliding roof structure or an elongated hole in the second web and an elongated hole in the sliding roof structure, which are in particular at least substantially oriented in vehicle transverse and longitudinal direction or both in vehicle transverse direction and can be screwed together with a nut or similar female threaded element on both sides. Because of this, a production effort in an embodiment can be reduced and/or an assembly improved.

Accordingly, a first hole arrangement in an embodiment can be formed in the connecting flange and/or in the lateral roof frame, a second hole arrangement in the connecting flange and/or in the sliding roof structure, wherein at least one first hole arrangement and/or at least one second hole arrangement is a (first or second) elongated hole arrangement.

Additionally or alternatively to a screw connection in particular one explained above and thus frictionally joined connection of the first web to the lateral roof frame and/or of the second web to the sliding roof structure, the first web can be or will be connected in a positively joined manner to the lateral roof frame and/or the second web to the sliding roof structure. The positively joined connection can in particular replace a frictionally joined connection. Because of this, the assembly effort can be reduced in an embodiment.

Equally, the first web can be initially connected in an embodiment to the lateral roof frame in a positively joined and subsequently frictionally joined manner and/or the second web initially connected in a positively and subsequently frictionally joined manner to the sliding roof structure. In this way, the positively joined connection in an embodiment can serve as assembly aid, thus improving assembly. In particular for a positively joined connection, one or multiple, in particular all elongated holes of the first and/or second elongated hole arrangement are formed keyhole-like in an embodiment and each have an enlarged insertion region and a fixing region adjoining thereon, which narrows compared with the insertion region. One or multiple of these elongated holes can then each be or will be engaged behind by a pin in a further development and thus connect the connecting flange to the roof frame or the sliding roof structure in a positively joined manner.

The pin engaging behind can be permanently connected to the one of the connecting flange, the roof frame or the sliding roof structure. In particular, the pin can be integrally formed therewith or connected in a positively joined manner therewith and engage through and behind with its free end the keyhole-like elongated hole in the other one of the connecting flange, the roof frame or the sliding roof structure. Thus, a pin which is in particular permanently connected to the first web can engage through a keyhole-like elongated hole in the roof frame, a pin that is permanently connected to the second web engage through a keyhole-like elongated hole in the sliding roof structure, a pin which is permanently connected to the roof frame engage through a keyhole-like elongated hole in the first web and/or a pin which is permanently connected to the sliding roof structure engage through a keyhole-like elongated hole in the second web and in each case engage behind it with its free end. The pin for this purpose has an undercut on its free end in an embodiment, which interacts with the narrowed fixing region and fixes the connecting flange in a positively joined manner, wherein the free end of the pin will be or is inserted through the enlarged insertion region and subsequently guided on into the narrowed fixing region, engaging behind this with its undercut.

In an embodiment, one or multiple, in particular all keyhole-like elongated holes of the first and/or second elongated hole arrangement, can also be or will be engaged through by threaded pins, which are or become screwed together on one or both sides, wherein the enlarged insertion region can facilitate inserting the threaded pins. In an embodiment, one or multiple, in particular all elongated holes of the first and/or second elongated hole arrangement are formed open on one side in elongated hole longitudinal direction so that in particular in a further development a (threaded) pin can also be inserted through the open side. Because of this, the (dis)assembly can be facilitated in an embodiment.

In an embodiment, the sliding roof structure will be or is connected to a plate-like roof element. In a further development, this can take place or be carried out together with or after a connecting of the first web to the lateral roof frame and/or together with or after a connecting of the second web to the sliding roof structure. Sliding roof structure and plate-like roof element can become connected or are connected in particular in a frictionally joined manner, in particular through hem or flange pressing. Equally, sliding roof structure and plate-like roof element can also become or are connected in a materially joined manner in an embodiment, in particular through welding, soldering or gluing.

In particular in connection with such a plate-like roof element, the first and/or second elongated hole arrangement can compensate tolerances and/or improve the assembly.

In an embodiment, the second web is initially connected to the sliding roof structure in a frictionally and/or positively joined manner by means of the second elongated hole arrangement, if appropriate after the sliding roof structure has been connected to the plate-like roof element. Following this, the first web is connected to the lateral roof frame in a frictionally and/or positively joined manner by means of the first elongated hole arrangement. In an embodiment, the tolerances which occur in particular through the connecting of the sliding roof structure to the plate-like roof element and/or the second web can be compensated in particular. Equally, the first web can conversely be initially connected also to the lateral roof frame and subsequently the second web to the sliding roof structure.

### BRIEF DESCRIPTION OF THE DRAWINGS

The present disclosure will hereinafter be described in conjunction with the following drawing figures, wherein like numerals denote like elements.

FIG. 1 shows a part of a motor vehicle body according to an embodiment of the present disclosure in perspective view; and

FIG. 2 shows a part of a motor vehicle body according to a further embodiment of the present disclosure in perspective view.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

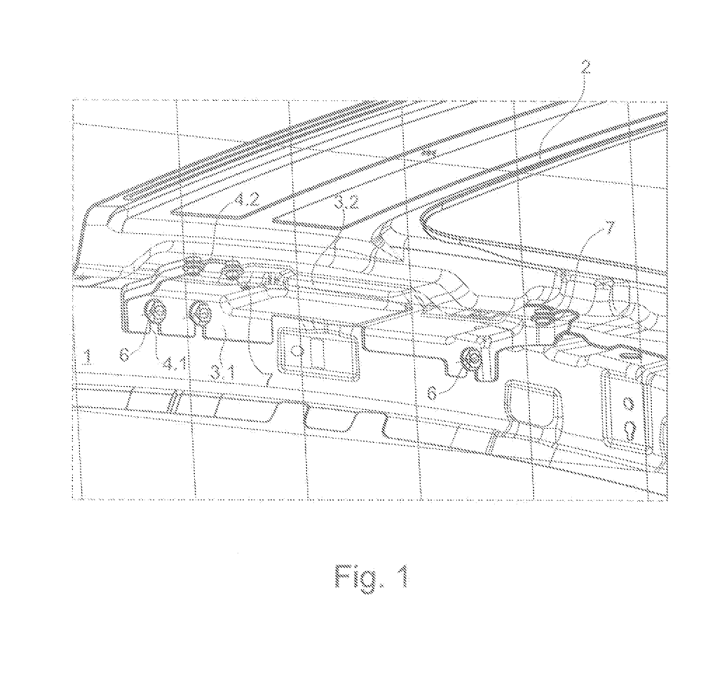

FIG. 1 shows a part of a motor vehicle body according to an embodiment of the present disclosure in perspective view from inside the vehicle. The motor vehicle body includes a lateral roof frame 1, a sliding roof structure in the form of a sliding roof housing 2 and an angled connecting flange with a first web 3.1 and a second web 3.2.

The first web 3.1 includes a first elongated hole arrangement with three elongated holes 4.1 which are open on one side in elongated hole longitudinal direction, the elongated hole longitudinal direction of which is oriented in vehicle vertical direction (vertical in FIG. 1). The second web 3.2 includes a second elongated hole arrangement with three elongated holes 4.2 which are open on one side in elongated hole longitudinal direction, the elongated hole longitudinal direction of which is oriented in vehicle transverse direction (substantially horizontal in FIG. 1).

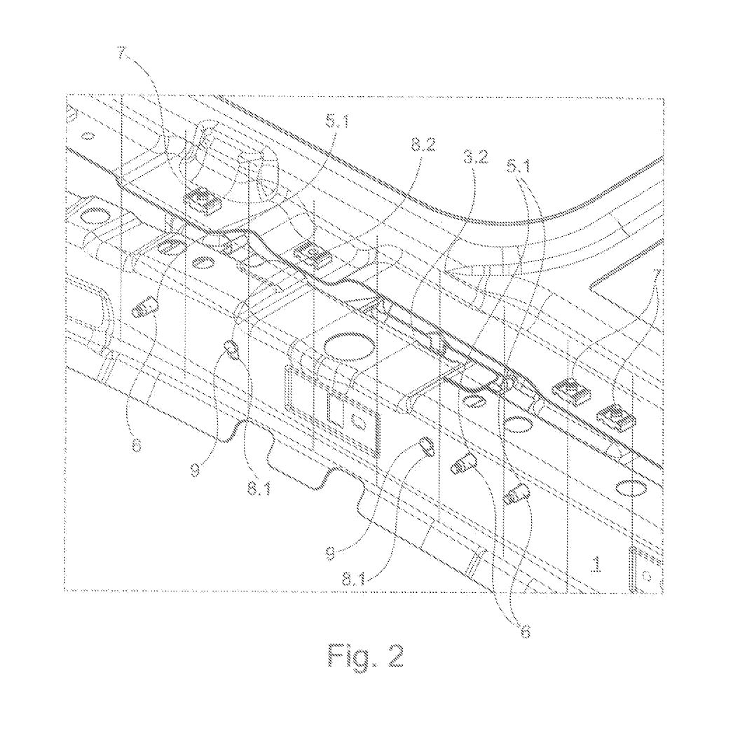

The lateral roof frame 1 includes a corresponding round hole arrangement with three round holes 5 (see FIG. 2), which are aligned with the three elongated holes 4.1 of the first elongated hole arrangement in vehicle transverse direction. The sliding roof housing 2 includes a corresponding round hole arrangement with three round holes, which are aligned with the three elongated holes 4.2 of the second elongated hole arrangement in vehicle vertical direction. The three elongated holes 4.1 of the first elongated hole arrangement and the round holes 5 of the round hole arrangement in the lateral roof frame 1 aligned therewith and the three elongated holes 4.2 of the second elongated hole arrangement and the round holes of the round hole arrangement in the sliding rood structure aligned therewith will be or are each engaged through by threaded pins 6 and 7 respectively, which on the vehicle inside (see FIG. 1) are provided with a screw head and on the vehicle inside are screwed together with a nut or similar female threaded element, thus connecting the connecting flange to the lateral roof frame 1 respectively the sliding roof structure 2 in a frictionally joined manner.

In a method according to an embodiment of the present disclosure, a plate-like roof element (not shown) is initially connected to the sliding roof housing 2 through hem pressing. Following this, the roof element and the sliding roof housing 2 connected therewith are placed onto the lateral roof frame 1. The vertical threaded pins 7 are now passed through the elongated holes 4.2 of the second elongated hole arrangement in the second web 3.2 and the round holes in the sliding roof housing 2 aligned therewith and screw together with the nuts on the vehicle outside (not visible in FIG. 1). Following this, the horizontal threaded pins 6 are passed through the elongated holes 4.1 of the first elongated hole arrangement in the first web 3.1 and the round holes in the lateral roof frame 1 aligned therewith and screwed together with the nuts on the vehicle outside (not visible in FIG. 1).

FIG. 2 shows a part of a motor vehicle body according to a further embodiment of the present disclosure in perspective view from the vehicle outside. Elements which correspond to one another are marked with identical reference characters so that reference is made to the remaining description and differences are discussed in the following. Noticeable in particular are the threaded pins 6, 7 already explained above with reference to the embodiment of FIG. 1 (for improved clarity without nuts on the vehicle outside), which engage through the round holes 5.1 in the lateral roof frame 1 and the elongated holes (not visible) in the second web 3.2.

In the embodiment of FIG. 2, the first web 3.1 is connected to the lateral roof frame 1 initially in a positively and subsequently frictionally joined manner. To this end, one or multiple keyhole-like elongated holes with an insertion region 8.1 and a fixing region 8.2 adjoining thereon are formed in the lateral roof frame, which fixing region 8.2 narrows compared with the insertion region 8.1. On the first web 3.1, pins 9 aligned thereto are arranged, which engage behind these keyhole-like elongated holes, thus connecting the connecting flange to the roof frame 1 in a positively joined manner.

For the assembly, the pins 9 are initially inserted in vehicle transverse direction into the insertion regions 8.1 and subsequently guided on in vehicle vertical direction into the narrowed fixing region 8.2, which they engage behind in the process thus initially connecting the connecting flange to the lateral roof frame 1 in a positively joined manner.

Following this, as previously explained with reference to the embodiment of FIG. 1, the vertical threaded pins 7 are passed through the elongated holes 4.2 of the second elongated hole arrangement in the second web 3.2 and the round holes in the sliding roof housing 2 aligned therewith and screwed together with the nuts on the vehicle outside (not visible in FIG. 1), and following this, beforehand or parallel to this, the horizontal threaded pins 6 are passed through the elongated hole 4.1 of the first elongated hole arrangement in the first 3.1 and the round holes in the lateral roof frame 1 aligned therewith and screw together with the nuts on the vehicle outside, so that the connecting flange will be or is connected to the sliding roof housing 2 and the roof frame 1 in a frictionally joined manner.

In a modification which is not shown, the horizontal threaded pins 6 with the embodiment of FIG. 2 can also be omitted so that the connecting flange is only connected to the roof frame 1 in a positively joined manner via the pins 9, which engage behind the narrowed fixing regions 8.2 of the keyhole-like elongated holes in the lateral roof frame.

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-11. (canceled)

12. A motor vehicle body comprising:
a lateral roof frame;
a sliding roof structure; and
an angled connecting flange having a first web connected to the lateral roof frame by means of a first elongated hole arrangement and a second web connected to the sliding roof structure by means of a second elongated hole arrangement.

13. The motor vehicle body according to claim 12, wherein the first elongated hole arrangement is formed in one of the angled connecting flange or the lateral roof frame and substantially oriented in one of a vehicle vertical direction or a vehicle longitudinal direction.

14. The motor vehicle body according to claim 13, wherein the second elongated hole arrangement is formed in one of the angled connecting flange or the sliding roof structure and is at least substantially oriented in vehicle transverse direction or a vehicle longitudinal direction.

15. The motor vehicle body according to claim 12 wherein at least one of the first elongated hole arrangement and the second elongated hole arrangement comprises at least one elongated hole which is open on one side in an elongated hole longitudinal direction.

16. The motor vehicle body according to claim 12 wherein the first elongated hole arrangement further comprises a threaded pin extending through an elongated hole and a female threaded element screwed together to connect the connecting flange to one of the roof frame or the sliding roof structure in a frictionally joined manner.

17. The motor vehicle body according to claim 12 wherein the first elongated hole arrangement further comprises a threaded pin extending through an elongated hole and a female threaded element screwed together to connect the connecting flange to one of the roof frame or the sliding roof structure in a materially joined manner.

18. The motor vehicle body according to claim 12, wherein at least one of the first elongated hole arrangement and the second elongated hole arrangement comprises a keyhole-like elongated hole having an insertion region and a fixing region adjoining thereon, which narrows relative to the insertion region.

19. The motor vehicle body according to claim 17, wherein the keyhole-like elongated hole is engaged behind by a pin which connects the connecting flange to one of the roof frame or the sliding roof structure in a positively joined manner.

20. The motor vehicle body according to claim 12, wherein the sliding roof structure is connected to a plate-like roof element in a frictionally joined manner.

21. The motor vehicle body according to claim 12, wherein the sliding roof structure is connected to a plate-like roof element in a materially joined manner.

22. A method for producing a motor vehicle body according to any one of the preceding claims, with the steps:
locating a first web on an angled connecting flange adjacent a lateral roof frame
interconnecting the first web of the angled connecting flange to the lateral roof frame by means of a first elongated hole arrangement;
locating a second web on the angled connecting flange adjacent a sliding roof structure; and
interconnecting the second web to the sliding roof structure by means of a second elongated hole arrangement.

23. The method according to claim 22, further comprising interconnecting the first web to the lateral roof frame initially in a positively joined manner and subsequently in a frictionally joined manner.

24. The method according to claim 22, further comprising interconnecting the second web to the sliding roof structure initially in a positively joined manner and subsequently in a frictionally joined manner.

25. The method according to 22 further comprising interconnecting the sliding roof structure to a plate-like roof element in at least one of a frictionally joined manner or a materially joined manner.
